(19) United States
(12) Patent Application Publication
(10) Pub. No.: US 2008/0040918 A1
(43) Pub. Date: Feb. 21, 2008

(54) COMPUTER PERIPHERAL INSTALLATION APPARATUS

(75) Inventors: YAO-ZHONG CHEN, Shenzhen (CN); GUANG YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/836,803

(22) Filed: Aug. 10, 2007

(30) Foreign Application Priority Data
Aug. 18, 2006 (CN) 200620200716.7

(51) Int. Cl. B23P 19/00

(52) U.S. Cl. 29/760; 29/729; 361/683

(57) ABSTRACT

A computer peripheral installation apparatus is disclosed. The computer peripheral installation apparatus includes a platform, an arm, a rack, an L-shaped block bar and a rack door. The arm is fixed on the platform and extends upwardly. The rack is rotatably mounted on the arm, defines a receiving space therein, and an entrance. The L-shaped block bar is placed on an end of the receiving space opposite the entrance. The rack door is mounted on the rack and is able to open or close the entrance. The computer peripheral installation apparatus is used to assemble a disk drive unit.

### BACKGROUND

1. Technical Field

The present invention relates to a computer installation apparatus, particularly to an installation apparatus for mass storage devices.

2. General Background

Mass storage devices, such as optical drives and hard disk drives are usually fixed on a drive mount and mounted in a computer case. This mounting process can be explained by referring to FIG. 1. FIG. 1 shows a drive mount 11 receiving two optical drives 12. The drive mount 11 and the optical drives 12 compose an optical drive unit 10. The drive mount 11 defines holes 13 at opposite sides of the drive mount 11. The optical drives 12 define holes (not shown) corresponding to the holes 13 of the drive mount 11.

When assembling the optical drive unit 10, a side of the drive mount 11 must be positioned manually in order that the holes 13 in the side of the drive mount 11 must aligned with the holes in the optical drives 12 to allow screws (not shown) to pass through the holes 13 and engage with the holes in the optical drives 12, thus, fixing the optical drives 12 onto the drive mount 11. Finally, the optical drive unit 10 may need to be repositioned again such that the holes in the opposite side of the drive mount 11 is aligned with the corresponding holes in the optical drives 12.

To align the holes 13 of the drive mount 11 with the holes in the optical drives 12 are difficult and may cause alignment errors. The same problems may occur when assembling a hard disk drive unit.

Therefore, what is needed is an installation apparatus for mass storage devices.

### SUMMARY

A computer peripheral installation apparatus is disclosed. The computer peripheral installation apparatus includes a platform, an arm, a rack, an L-shaped block bar and a rack door. The arm is fixed on the platform and extends upwardly. The rack is rotatably mounted on the arm, defines a receiving space therein and an entrance. The L-shaped block bar is placed on an end of the receiving space opposite the entrance. The rack door is mounted on the rack and is configured for closing or opening the entrance.

Further features and advantages will be provided or will become apparent in the course of the following detailed description.

### BRIEF DESCRIPTION OF THE DRAWINGS

FIG. 1 is a schematic, isometric view of an optical drive unit;

FIG. 2 is a schematic, side view of a computer peripheral installation apparatus according to a preferred embodiment of the present invention;

FIG. 3 is a schematic, isometric view of the computer peripheral installation apparatus of FIG. 2, a rack of the computer peripheral installation apparatus is inverted relative to FIG. 2;

FIG. 4 is a schematic, front view of the computer peripheral installation apparatus of FIG. 2, showing how the rack rotates;

FIG. 5 is a schematic, isometric view showing a first step of assembling the optical drive unit of FIG. 1 by using the computer peripheral installation apparatus of FIG. 2; and

FIG. 6 is a schematic, isometric view showing a second step of assembling the optical drive unit of FIG. 1 by using the computer peripheral installation apparatus of FIG. 2.

### DETAILED DESCRIPTION OF THE EMBODIMENT

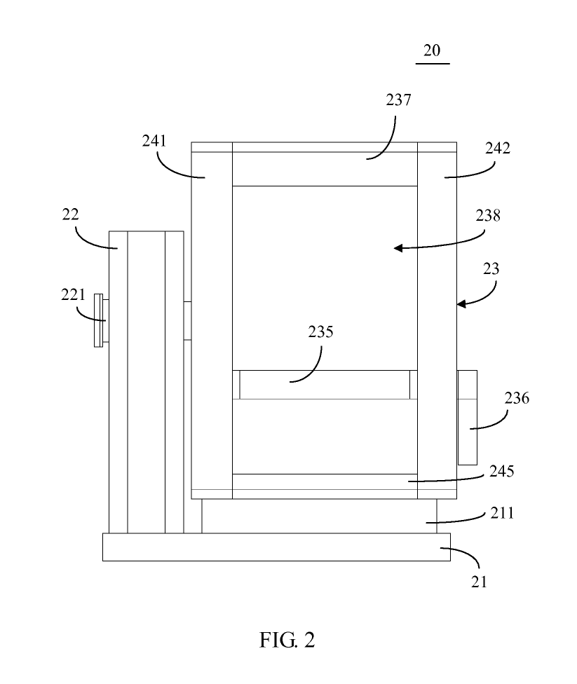

Referring to FIG. 2, a computer peripheral installation apparatus is disclosed. The computer peripheral installation apparatus 20 includes a platform 21, an arm 22, and a rack 23. The arm 22 extends upwardly from the platform 21 and connects with the rack 23.

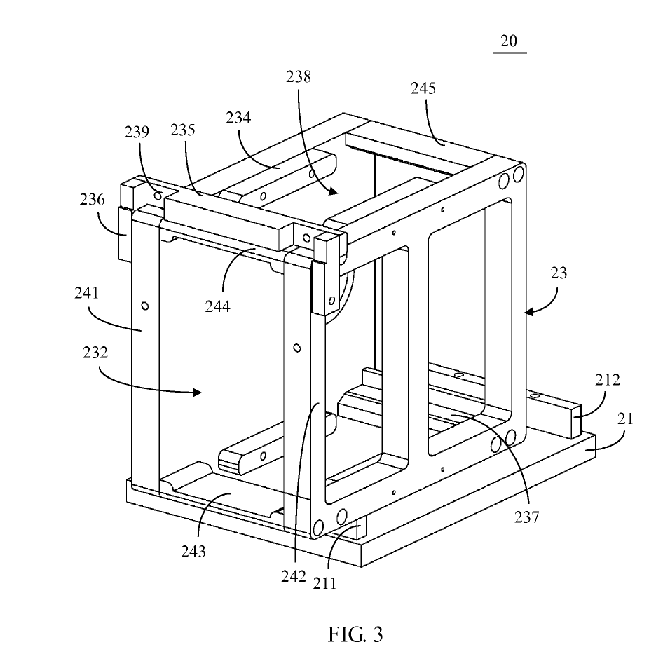

Referring to FIG. 3, the platform 21 is a rectangular plate. Two support bars 211, 212 are mounted on the platform 21 at two short sides of the platform 21 and are parallel to the short sides respectively. The support bars 211, 212 are used for supporting the rack 23.

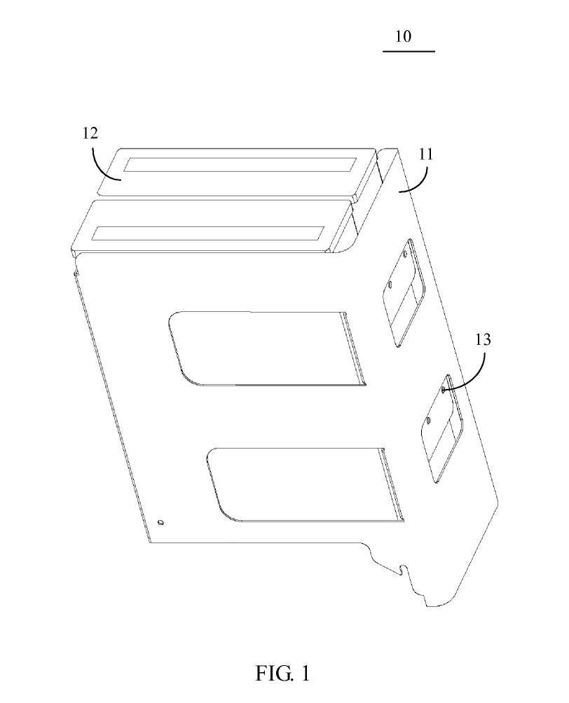

The rack 23 is substantially a cuboid. The rack 23 is composed of sides 241, 242, connecting bars 243, 244, 245, and an L-shaped block bar 237. The sides 241, 242 are parallel to each other on opposite sides of the rack 23. The connecting bars 243, 244, 245, and the L-shaped block bar 237 correspondingly connects from side 241 to side 242. The connecting bars, 243, 244, 245 and the L-shaped block bar 237 cooperatively define a receiving space 238 for receiving an optical drive unit 10 as that shown in FIG. 1. The connecting bars 243, 244 and the sides 241, 242 cooperatively define an entrance 232 of the receiving space 238. The rack 23 includes four guide rails 234, two of the guide rails 234 are mounted at top ends of the sides 241, 242 and another two of the guide rails 234 are mounted at bottom ends of the side walls 241, 242 correspondingly. Two hinges 236 are correspondingly mounted on the sides 241, 242. The hinges 236 are mounted near the connecting bar 244. The two hinges 236 further connect to opposite ends of a rack door 235, thus the rack door 235 is movable to block or open the entrance 232. The rack door 235 includes two depressed portion 239 at opposite ends. The depressed portions 239 connect to the hinges 236. Furthermore, the depressed portions 239 receive a portion of the sides 241, 242 when the rack door 235 is in a close position, thus, the rack door 235 can fully enter into the entrance 232 by avoiding interference of the sides 241, 242.

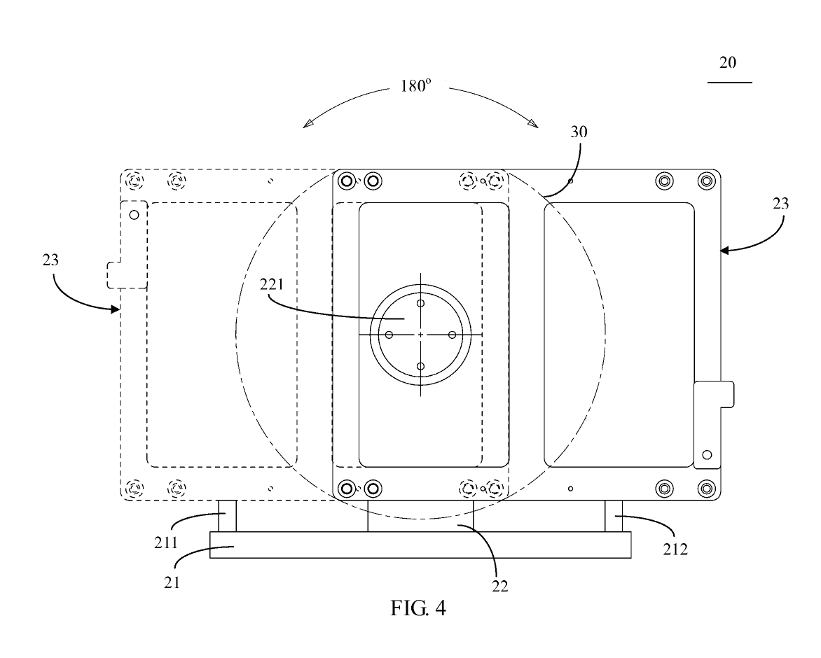

Referring to FIGS. 2 and 4 together, the rack 23 is rotatably mounted on the arm 22 via a pivot shaft 221. The shaft 221 extends substantially parallel to a surface normal to the outer surface of the side 241 at a middle portion near the connecting bar 245 and the block bar 237. A distance between a center of the shaft 221 and a closest corner of the rack 23 is smaller than a distance between the center of the shaft 221 and an upper surface of the platform 21. Thus, the rack 23 can be rotated 180 degrees without touching the platform 21.

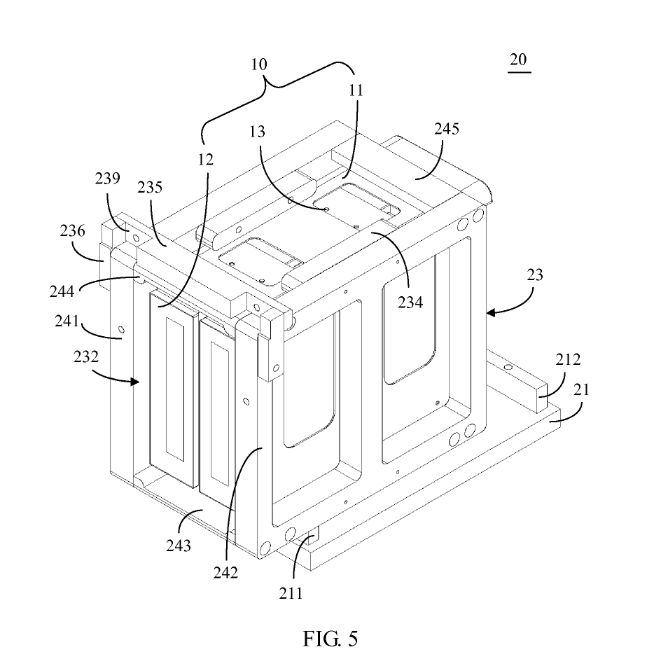

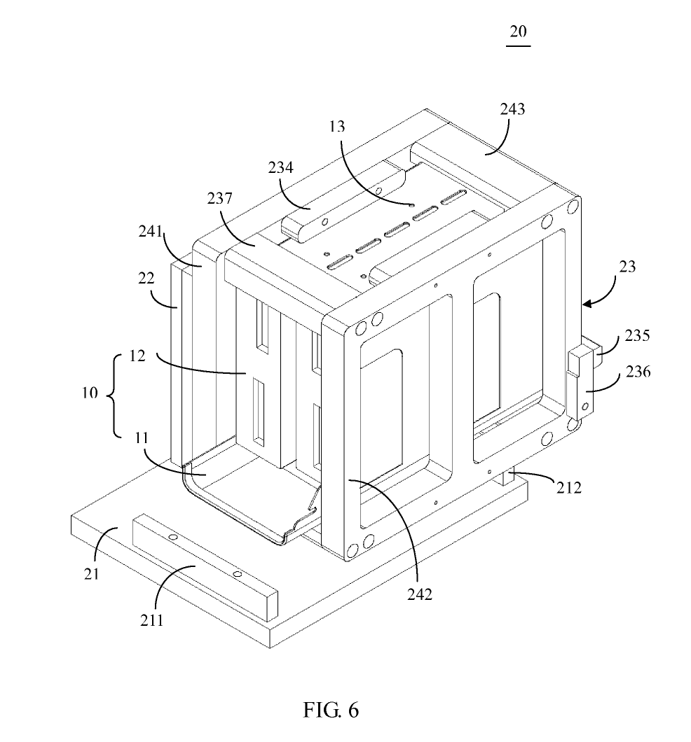

When assembling an optical drive unit 10, refer to FIG. 5, first rotate the rack 23 to a first position such that the rack 23 rests on the support bar 211. The rack door 235 is lifted and a drive mount 11 is inserted into the receiving space 238 through the entrance 232. Two optical drives 12 are then placed in the drive mount 11. The rack door 235 is closed such that the rack door 235 blocks the entrance 232, thus opposite ends of the optical drives 12 and the drive mount 11 are held in place by the rack door 235 and the L-shaped block bar 237. Furthermore, holes 13 of the drive mount 11 are aligned with the holes of the optical drives 12. Screws are then screwed through a side of the drive mount 11 exposed. Referring to FIG. 6, the rack 23 is then rotated by 180° such that the rack 23 rests on the support bar 212 and screws are screwed through another side of the drive mount 11. After the optical drive unit 10 composing the two optical drives 12 and the drive mount 11 is fixed, open the rack door 235 and retrieve the optical drive unit 10 from the rack 23.

The computer peripheral installation apparatus 20 can also be used to assemble a hard disk drive unit. For simplicity, the description of assembling the hard disk drive unit by utilizing the computer peripheral installation apparatus 20 is omitted herein.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A computer peripheral installation apparatus comprising:
a platform;
an arm fixed on the platform, extending upwardly from the platform;
a rack rotatably mounted on the arm, defining a receiving space and an entrance;
an L-shaped block bar placed on an end of the receiving space opposite to the entrance, and
a rack door mounted on the rack, configured for to closing or opening the entrance.

2. The computer peripheral installation apparatus of claim 1, wherein the rack is substantially a cuboid.

3. The computer peripheral installation apparatus of claim 2, wherein the rack is composed by two parallel sides and a plurality of connecting bars, wherein the connecting bars connect the two sides.

4. The computer peripheral installation apparatus of claim 3, further comprising a plurality of guide rails mounted at top or bottom ends of the sides.

5. The computer peripheral installation apparatus of claim 1, further comprising two support bars mounted on the platform for supporting the rack.

6. The computer peripheral installation apparatus of claim 1, wherein the rack connects with the arm by a pivot shaft.

7. The computer peripheral installation apparatus of claim 1, further comprising two hinges connect the rack door with the rack.
